(19) United States
(12) Patent Application Publication
(10) Pub. No.: US 2026/0067062 A1
(43) Pub. Date: Mar. 5, 2026

(54) METHOD AND DEVICE WITH INTERSECTION AND LABEL OPERATIONS

(71) Applicants: SAMSUNG ELECTRONICS CO., LTD., Suwon-si (KR); IUCF-HYU (Industry-University Cooperation Foundation Hanyang University), Seoul (KR)

(72) Inventor: Miran KIM, Seoul (KR)

(73) Assignees: SAMSUNG ELECTRONICS CO., LTD., Suwon-si (KR); IUCF-HYU (Industry-University Cooperation Foundation Hanyang University), Seoul (KR)

(21) Appl. No.: 19/067,035

(22) Filed: Feb. 28, 2025

(30) Foreign Application Priority Data
Sep. 2, 2024 (KR) 10-2024-0118841

(51) Int. Cl. H04L 9/00; H04L 9/06

(52) U.S. Cl. CPC H04L 9/008; H04L 9/0618; H04L 9/0662

(57) ABSTRACT

A processor-implemented method including generating intersection operation result ciphertext by performing an intersection operation between a first ciphertext, the first ciphertext corresponding to elements of a first data set of a first device, and elements of a second data set of a second device, based on a matching function defined for the elements of the second data set, generating a label ciphertext by encrypting label information obtained from the elements of the second data set, and generating a final ciphertext based on the intersection operation result ciphertext and the label ciphertext.

### CROSS-REFERENCE TO RELATED APPLICATIONS

This application claims the benefit under 35 USC § 119(a) of Korean Patent Application No. 10-2024-0118841, filed on Sep. 2, 2024, in the Korean Intellectual Property Office, the entire disclosure of which is incorporated herein by reference for all purposes.

### BACKGROUND

### 1 Field

The following description relates to a method and device with intersection and label operations, and more particularly, a method of performing a private set intersection (PSI) operation having low calculation complexity.

### 2. DESCRIPTION OF RELATED ART

As the importance of privacy for user data increases, laws related to personal data protection, such as the General Data Protection Regulation (GDPR) of the European Union, have been enacted. However, data retainers or collectors may have difficulty providing or using a service using information related to personal data protection. Due to this, there is a desire for privacy protection techniques for personal data protection, and research for a private set intersection (PSI) technique for determining data matching in an encrypted state without exposing the data has been explored.

The PSI technique is an example of multi-party computation (MPC). The PSI technique finds an intersection (common elements) without exposing sets respectively retained by two entities and typical PSI techniques may include hash-based PSI, public key password-based PSI, circuit-based PSI, and oblivious transfer-based PSI. However, these typical techniques may not be able to perform an intersection operation on a large volume of data is or their operation speeds are significantly slowed because, as a comparison target increases, an amount of data transmission or computation between two entities for an intersection operation significantly increases.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including generating intersection operation result ciphertext by performing an intersection operation between a first ciphertext, the first ciphertext corresponding to elements of a first data set of a first device, and elements of a second data set of a second device, based on a matching function defined for the elements of the second data set, generating a label ciphertext by encrypting label information obtained from the elements of the second data set, and generating a final ciphertext based on the intersection operation result ciphertext and the label ciphertext.

The generating of the final ciphertext may include generating random number ciphertext based on a generated random number and the intersection operation result ciphertext and generating the final ciphertext based on the random number ciphertext and the label ciphertext.

The generating of the random number ciphertext may include multiplying the random number by the intersection operation result ciphertext to generate the random number ciphertext.

The generating of the final ciphertext may include adding the random number ciphertext to the label ciphertext to generate the final ciphertext.

Among the elements of the second data set, a final ciphertext corresponding to an element included in an intersection with the first data set may be the same as the label ciphertext.

The generating of the intersection operation result ciphertext may include for each element of the second data set, calculating differences between an element of the second data set and the elements of the first data set and generating the intersection operation result ciphertext by multiplying the calculated differences.

The method may further include transmitting the final ciphertext to the first device, and the first device may provide the first ciphertext.

A first number of elements of the first data set may be less than a second number of elements of the second data set.

In generating the final ciphertext, an accumulated number of homomorphic encryption operations may be two.

The ciphertext may be a ring learning with error (RLWE)-based ciphertext.

In a general aspect, here is provided a non-transitory computer-readable storage medium storing instructions that, when executed by a processor, cause the processor to perform the method.

In a general aspect, here is provided an electronic device including processors configured to execute instructions and a memory storing the instructions, and an execution of the instructions configures the processors to perform an intersection operation between a first ciphertext, the first ciphertext including first elements of a first data set, and second elements of a second data set to generate an intersection operation result ciphertext based on a matching function defined for the elements of the second data set, generate a label ciphertext by encrypting label information from the second elements of the second data set, and generate a final ciphertext based on the intersection operation result ciphertext and the label ciphertext.

The processors may be further configured to generate a random number ciphertext based on a generated random number and the intersection operation result ciphertext and generate the final ciphertext based on the random number ciphertext and the label ciphertext.

The processors may be further configured to multiply the random number by the intersection operation result ciphertext to generate the random number ciphertext.

The processors may be further configured to add the random number ciphertext to the label ciphertext to generate the final ciphertext.

Among the elements of the second data set, a final ciphertext corresponding to an element included in an intersection with the first data set may be the same as the label ciphertext.

The processors may be further configured to, for each element of the second data set, calculate differences between an element of the second data set and the elements of the first data set and generate the intersection operation result ciphertext by multiplying the calculated differences.

A first device may provide the first ciphertext, a second device may provide the second data set, and the processors may be further configured to transmit the final ciphertext to the first device.

A first number of elements of the first data set may be less than a second number of elements of the second data set.

In generating the final ciphertext, an accumulated number of homomorphic encryption operations may be two.

Other features and aspects will be apparent from the following detailed description, the drawings, and the claims.

### BRIEF DESCRIPTION OF THE DRAWINGS

FIG. 1A illustrates an example electronic apparatus for encryption according to one or more embodiments.

FIG. 1B illustrates example data sets for encryption according to one or more embodiments.

FIG. 2 illustrates an example electronic device according to one or more embodiments.

FIG. 3 illustrates an example electronic device according to one or more embodiments.

FIG. 4 illustrates example operations of a first electronic device and a second electronic device according to one or more embodiments.

FIG. 5 illustrates an example method of generating final ciphertext according to one or more embodiments.

FIG. 6 illustrates an example method according to one or more embodiments.

FIG. 7 illustrates an example electronic device according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

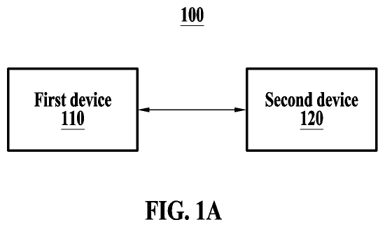

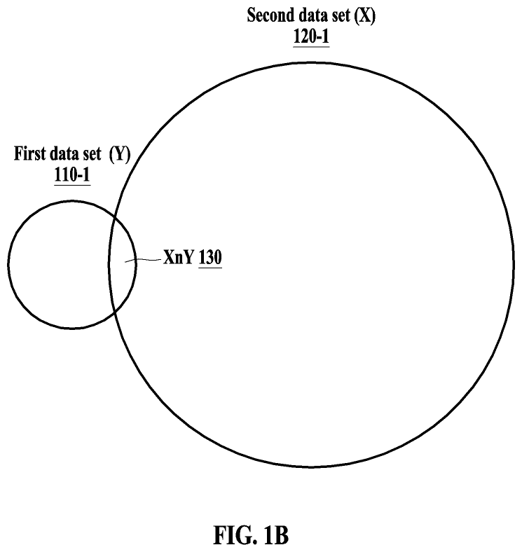

FIG. 1A illustrates an example electronic apparatus for encryption according to one or more embodiments.

Referring to FIG. 1A, in a non-limiting example, an electronic apparatus 100 for encryption may include a first device 110 and a second device 120.

In an example, the electronic apparatus 100 may be a system for generating an intersection between data retained by the first device 110 and data retained by the second device 120 without directly exposing the data retained by the first device 110 and the second device 120 to each other.

The 100 may provide a private set intersection (PSI) protocol. The PSI may be an encryption technique for protecting privacy for a data set of each party while finding a common element by comparing data sets of two parties (e.g., the first device 110 and the second device 120). Through the PSI protocol, the two parties may securely verify only the common element without exposing their data elements to each other. The purpose of PSI may be efficiently finding a common element between two data sets while protecting the data privacy. Each party may compare its data set in an encrypted state, and thereby, may not be allowed to know any information about the data of the other party except for the common element.

Homomorphic encryption may be an encryption technique for performing an operation on encrypted data without decryption. When various operations are performed on homomorphically encrypted data, the operations results are the same as operations results performed on unencrypted data. Since the homomorphic encryption may process data while the data is encrypted, privacy concerns in the data industry may be relieved. For example, the electronic apparatus 100 may be applied to various systems, such as password monitoring, finding contacts, file sharing, and key searching in a mobile messenger. However, the system to which the electronic apparatus 100 is applied is not limited to the example described above.

The electronic apparatus 100 may find a common element by comparing the data retained by the first device 110 with the data retained by the second device 120 and may provide a PSI protocol including a label (a labeled PSI protocol) for exchanging label information about the common element. In this process, each party may not expose its data element and the label information and may maintain data privacy using the homomorphic encryption (HE) technique.

More specifically, the electronic apparatus 100 may provide a method of securely calculating an intersection of the data retained by the first device 110 and the data retained by the second device 120 through the labeled PSI protocol and exchanging label information about elements included in the intersection. The label information may be an additional description, identification, or classification information added to a data element and may indicate a specific attribute or meaning of the data element. The label information may be used to provide information, such as the characteristics of a specific data element, a category to which the specific data element belongs, or additional metadata. The label information may provide context of an element or additional information for data processing.

For example, the electronic apparatus 100 may be used to determine whether a common patient, in other words, the same patient is registered in two medical institutions (e.g., the first device 110 and the second device 120) by comparing patient data sets respectively retained by the two medical institutions. Each medical institution may retain a data set including identification information, such as a name, date of birth, and gender of a patient, as well as label information such as a diagnosis result and a treatment state of the patient. In an example, the two institutions may both identify the same patient without exposing patient identification information and securely exchange the label information, such as a diagnosis result and a treatment state of the patient, through the electronic apparatus 100.

FIG. 1B illustrates example data sets for encryption according to one or more embodiments.

Referring to FIG. 1B, in a non-limiting example, the first device 110 may retain a first data set 110-1 (e.g., a set Y) and the second device 120 may retain a second data set 120-2 (e.g., a set X).

The sizes of the first data set 110-1 and the second data set 120-1 may be asymmetric. For example, the second device 120 may be a server for providing a big data-based PSI service (or may be referred to as a service provider or a sender device). The first device 110 may be a client terminal receiving the service (or may be referred to as a service user or a receiver device). In this case, the number of elements of the first data set Y may be significantly less than the number of elements of the second data set X.

The second device 120 may have label information (e.g., lₓ) for each element (e.g., x) of the second data set 120-1. The first device 110 may transmit a request to the second device 120 for the label information regarding an element corresponding to an intersection of the first data set 110-1 and the second data set 120-1.

In an example, the first device 110 may be a client receiving an advertisement targeting service and may retain the first data set 110-1 including a list of a customers interested in a specific product. The second device 120 may be a server providing an advertisement targeting service and may retain the second data set 120-1 including a large volume of user data. The service that the first device 110 desires to receive (i.e., the advertising target service) may be providing a customized advertisement that targets only customers interested in a specific product.

The first data set 110-1 may include only a customer identification (ID) and may not include the label information. On the other hand, the second data set 120-1 of the second device 120 may include label information, such as various interests, product categories, and a recent purchase history of a user in addition to a user ID for that user. In an example, through the labeled PSI protocol, the first device 110 may identify a common element (e.g., the same customer ID) by comparing customers included in the first data set 110-1 with the second data set 120-1.

In this process, the data of the first device 110 in an encrypted state may be transmitted to the second device 120 and the second device 120 may perform an intersection operation by comparing the first data set 110-1 in the encrypted state with the second data set 120-1.

In an example, the second device 120 may identify a common element through the intersection operation and may encrypt and transmit the label information about the common element to the first device 110. The second device 120 may calculate a matching function using the encrypted data received from the client and the second data set 120-1 and may generate a final ciphertext by integrating label information on each element corresponding to the intersection. For example, a matching function result and the label information may be integrated into one while the matching function result and the label information are encrypted and may be generated as the final ciphertext. The final ciphertext may be transmitted to the first device 110.

The first device 110 may simultaneously identify an intersection element and the corresponding label information by decrypting the final ciphertext received from the second device 120. For example, by decrypting the final ciphertext, the first device 110 may identify that a specific customer ID coincides with a user included in the second data set 120-1 and may identify the label information of the customer ID, such as various interests, product categories, and recent purchase history.

Through the electronic apparatus 100, the first device 110 may efficiently obtain, from the large volume of user data set 120-1 of the second device 120, additional information on customers of interest which may be used for customized advertisement targeting and personalized marketing campaigns. In addition, in this process, both the first device 110 and the second device 120 may maintain their own data privacy and may securely exchange data even in a situation in which data protection is important.

In an example, in a HE-based PSI protocol, when calculating a specific circuit in an encrypted state, a depth of the circuit may be one factor for determining the ciphertext size and amount of computation. Typically, as the depth of the circuit increases, the ciphertext size and the amount of computation may increase, and thereby, calculation efficiency may decrease. A problem, such as a this resulting decrease in efficiency may be increased when handling a large volume of data sets. When the size of a data set X of a service provider is |X|, a maximum degree of a matching function used in a typical HE-based PSI method may be determined by |X|. In the case of typical labeled PSI's, a label function may be defined based on a matching function, and thus, the circuit depth of the label function may depend on the depth of the matching function. Due to this, typical labeled PSI methods may have an inefficient operation as the size of data sets increases, and this may cause performance degradation in the actual application. Specifically, when the size of a data set retained by a service provider, for example, the second data set 120-1, is large, the typical matching function may require polynomial multiplication of as many as the number of elements of the second data sets 120-1, and due to this, the amount of computation may significantly increase. The problem described above may be one of main factors hindering the practical application of typical labeled PSI's.

Therefore, as discussed above, a typical PSI protocol has been described before describing the electronic apparatus 100 in greater detail below. In the typical PSI protocol, a matching function for a set element y∈Y of a service user may be defined as Equation 1 to design a PSI protocol.

$$F ( X ) = {\prod }_{x ∈ X} ( X - x ) \qquad Equation 1$$

Referring to equation 1, x may denote an element of the second data set X. If x that satisfies y=x exists, the matching function may have a value of “0”, and if not, the matching function may have a non-zero value.

When Enc(·) is an encryption function, Equation 2 may be calculated by a homomorphic encryption operation using encrypted information Enc(·).

$${\prod }_{x ∈ X} ( x - Enc ( y ) ) \qquad Equation 2$$

Furthermore, in the typical labeled PSI protocol, a polynomial I(X), which has a label information lₓ_{ᵢ} value in an element xᵢ of each set, in other words, which is I(xᵢ)=lₓ_{ᵢ}, may be defined using polynomial interpolation. A label function as Equation 3 may be defined using this.

$$G ( X ) = I ( X ) + F ( X ) \qquad Equation 3$$

Referring to Equation 3, when x that satisfies y=x exists, a function value F(y) of the matching function may have a value of “0” and a function value I(y) of a polynomial I(X) function may have a value of label information lₓ corresponding to y=x. Accordingly, a function value of the label function G(X) may be lₓ. Conversely, when x that satisfies y=x does not exist, the label function G (X) may have a non-lₓ value.

The circuit depth may represent an accumulated number of homomorphic multiplication operations. When the size of a set X of a service provider is |X|, since a maximum degree of Enc(y) of Equation 2 is |X|, the circuit depth of the matching function may be 0(log₂ log₂ |X|). In addition, the label function G(X) may be affected by the circuit depth of the polynomial I (X), and since the maximum degree of the label function G(X) is |X|, the circuit depth of the label function may also be 0(log₂ log₂ |X|). When performing an intersection analysis on a set X that is relatively large using the typical PSI protocol, the ciphertext may be very large and thus a large amount of computation may be required since the circuit depth is deep.

As described below, an electronic apparatus for encryption, such as the electronic apparatus 100 according to one or more embodiments, may perform a method that significantly reduces an amount of computation and optimizing a circuit depth by newly defining a matching function and a label function. Specifically, the electronic apparatus 100 may overcome the typical problem of increasing the amount of computation in proportion to the number of elements of the second data set 120-1 by improving a structure of the matching function. For this, the first device 110 may precompute information about the first data set Y and may transmit, to the second device 120, ciphertext generated by homomorphically encrypting the information. In addition, the electronic apparatus 100 may maximize the calculation efficiency of the label information based on an optimized circuit depth of the matching function through the design of the label function.

In an example, the electronic apparatus 100 may minimize the ciphertext size and the amount of computation when performing labeled PSI on a large volume of data sets and may allow efficient data exchange between a service provider and a client. This may ensure practical performance even if the size of the second data set 120-1 is large, and thereby, may improve the applicability in various application fields.

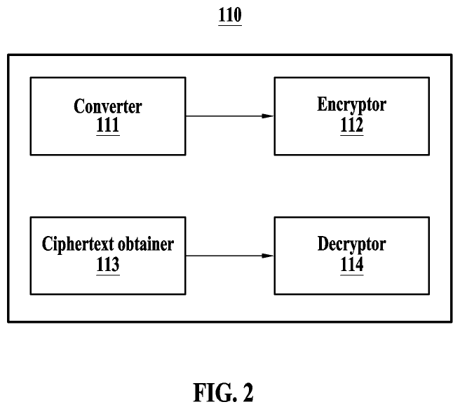

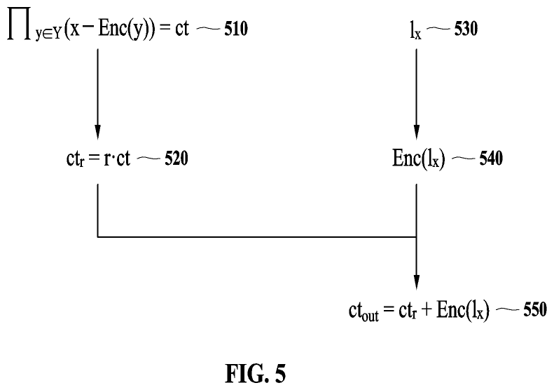

FIG. 2 illustrates an example electronic device according to one or more embodiments. The description provided with reference to FIGS. 1A and 1B may identically apply to FIG. 5.

Referring to FIG. 2, in a non-limiting example, the first device 110 may include a converter 111, an encryptor 112, a ciphertext obtainer 113, and a decryptor 114.

In an example, the first device 110 may perform encryption and decryption using homomorphic encryption. Homomorphic encryption may refer to a method of encryption configured to allow various operations to be performed on data that is encrypted. In homomorphic encryption, a result of an operation using ciphertexts may become a new ciphertext, and a plaintext obtained by decrypting the ciphertext may be the same as an operation result of the original data before the encryption.

Hereinafter, encrypted data or encrypted text may be referred to as a ciphertext. The ciphertext may be in the form of a polynomial or a vector including a polynomial.

In an example, the first device 110 may perform an encryption process of encrypting input data in privacy-preserving machine learning (PPML) and application services. The first device 110 may be used in an encryption process of encrypting an input value in PPML and application services.

The first device 110 may be implemented in the form of a chip and mounted on a hardware accelerator that utilizes homomorphic encryption. The first device 110 may be implemented in the form of a chip or software to reduce memory usage of various operation apparatuses. The first device 110 may reduce the amount of computation for the homomorphic encryption operation, thereby reducing the overall amount of computation of the server.

The first device 110 may be applied to any ring learning error (RLWE) problem-based homomorphic encryptions. The first device 110 may be implemented in an encryption process for encrypting an input value in any device and service for applying the homomorphic encryption.

The first device 110 may be included in a personal computer (PC), a data server, or a portable device. The portable device may be implemented as a laptop computer, a mobile phone, a smartphone, a tablet PC, a mobile internet device (MID), a personal digital assistant (PDA), an enterprise digital assistant (EDA), a digital still camera, a digital video camera, a portable multimedia player (PMP), a personal navigation device or portable navigation device (PND), a handheld game console, an e-book, or a smart device. The smart device may be implemented as a smartwatch, a smart band, or a smart ring.

In an example, the converter 111 may obtain an elementary symmetric polynomial corresponding to an element of the first data set. The converter 111 may obtain a k-th elementary polynomial symmetric polynomial b; corresponding to an element of the first data set Y. The elementary symmetric polynomial b; may be defined by Equation 4.

$$\begin{matrix}{b}_{1} & = {\sum }_{1 \leq j \leq n} {y}_{j} \\ {b}_{2} & = {\sum }_{1 \leq j < k \leq n} {y}_{j} {y}_{k} \\ {b}_{3} & = {\sum }_{1 \leq j < k < l \leq n} {y}_{j} {y}_{k} {y}_{l} \\ & ⋮ \\ {b}_{n} & = {y}_{1} {y}_{2} ⋯ {y}_{n}\end{matrix} \qquad Equation 4$$

The converter 111 may obtain a pre-calculation equation based on the elementary symmetric polynomial. The pre-calculation equation may be defined by Equation 5.

$${a}_{i} = \{ \begin{matrix}{( - 1 )}^{\vert Y \vert - i} {b}_{\vert Y \vert - i} , & i = 0 , 1 , … , \vert Y \vert - 1 \\ 1 , & i = \vert Y \vert\end{matrix} \qquad Equation 5$$

The encryptor 112 may generate ciphertext by encrypting the pre-calculation equation and may transmit ciphertext on the generated pre-calculation equation to the second device 120.

In an example, the encryptor 112 may generate the ciphertext of the pre-calculation equation using a homomorphic encryption algorithm. For example, the encryptor 112 may generate the ciphertext of the pre-calculation equation using an RLWE problem-based homomorphic encryption algorithm. The encryptor 112 may generate Enc (ai).

In an example, the ciphertext obtainer 113 may receive, from the second device 120, ciphertext on an element corresponding to the intersection of the first data set 110-1 and the second data set 120-1 and the label information corresponding to the element.

In an example, the decryptor 114 may obtain the element corresponding to the intersection and the label information corresponding to the element by decrypting final ciphertext received from the second device 120. In this case, the decryptor 114 may decrypt the ciphertext using a decryption algorithm of an encryption technique used for encryption by the encryptor 112.

Terms such as “-unit,” “-er (or),” etc., as used for the converter 111, the encryptor 112, the ciphertext obtainer 113, and the decryptor 114 may refer to a part for processing one or more functions or operations and may be implemented as hardware, software, or a combination of hardware and software. For example, the converter 111, the encryptor 112, the ciphertext obtainer 113, and the decryptor 114 of the first device 110 may be implemented in one or more processors.

In an example, the first device 110 may be implemented by more components than the illustrated components and the first device 110 may be implemented by fewer components. For example, the first device 110 may further include a memory. The processor may process data stored in a memory. The processor may execute a computer-readable code (for example, software) stored in the memory and instructions triggered by the processor.

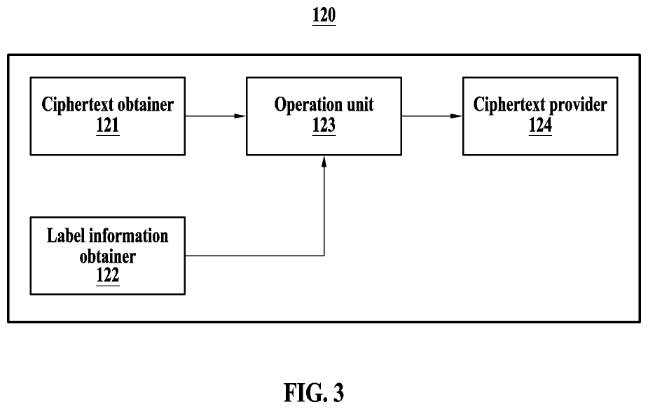

FIG. 3 illustrates an example electronic device according to one or more embodiments.

The description provided with reference to FIGS. 1A to 2 may also apply to FIG. 3.

Referring to FIG. 3, in a non-limiting example, the second device 120 may include a ciphertext obtainer 121, a converter 122, an operation unit 123, and a ciphertext provider 124.

In an example, the ciphertext obtainer 121 may receive, from the first device 110, ciphertext corresponding to an element of a first data set of the first device 110. In this case, the ciphertext obtained from the first device 110 may be generated in the same manner as described with reference to FIG. 2.

In an example, the second device 120 may define a matching function for an element x∈X of a second data set of the second device 120 as Equation 6.

$$F ( x ) = {\prod }_{y ∈ Y} ( x - y ) \qquad Equation 6$$

Referring to Equation 5, when y that satisfies y=x exists, the matching function may have a value of “0” and if not, may have a non-zero value.

In an example, the second device 120 may define a label function for each x∈X as Equation 7.

$$G ( x ) = r {\prod }_{y ∈ Y} ( x - y ) + {l}_{x} \qquad Equation 7$$

In Equation 7, r may denote a random number drawn from a uniform distribution. When y that satisfies y=x exists, the label function may have a value of lₓ and if not, may have a random number value.

In an example, when Enc(·) is an encryption function, the operation unit 123 may calculate Equation 8 using encrypted information Enc(·) through a homomorphic encryption operation.

$$F ( x ) = {\prod }_{y ∈ Y} ( x - Enc ( y ) ) \qquad Equation 8$$

In an example, when ciphertext ct=(c₀, c₁) calculated by Equation 8 is given, the label function may be calculated as Equation 9.

$$( {c}_{0}^{′} , {c}_{1}^{′} ) = r ( {c}_{0} , {c}_{1} ) + Enc ( {l}_{x} ) \qquad Equation 9$$

In Equation 8, Enc(lₓ) may be encrypted label information and may be referred to as label ciphertext. In addition, r(c₀, c₁) may be referred to as random number ciphertext and may be expressed by r·ct. Next,

$$( {c}_{0}^{′} , {c}_{1}^{′} )$$

may be an encrypted label function, may be referred to as final ciphertext, and may be expressed by ct′. Referring to Equation 8, the label function may be calculated in an encrypted state by one additional constant multiplication to intersection operation result ciphertext performed based on the matching function.

In an example, the ciphertext provider 124 may provide the final ciphertext generated by the operation unit 123 to the first device 110.

The first device 110 may obtain ciphertext on the label information lₓ when y that satisfies r exists by the random number y=x and may obtain label information lₓ by decrypting the ciphertext. For this, the first device 110 may have a secret key for decrypting the label information. When y that satisfies y=x does not exist, the first device 110 may obtain ciphertext unable to be decrypted by the random number r and accordingly, may not obtain the label information.

As the first device 110 pre-calculates information on the set Y and homomorphically encrypts the information, the matching function may be expressed by a linear combination of Enc(aᵢ) and xⁱ with the equation F(x) to be calculated in an encrypted state by the second device 120, and in this case, the circuit depth may be “1”.

When the circuit depth of the matching function is “1”, the circuit depth of the label function may be “2”, and thus, the electronic apparatus 100, in an example, may be implemented as a relatively small homomorphic encryption parameter. Accordingly, since the circuit depth may be shallow when performing an intersection analysis of a relatively large set X, the electronic apparatus 100 may have an advantage in that the ciphertext is small compared to the conventional PSI protocol and a small amount of computation is required, even when being performed on a relatively large dataset.

Terms such as “-unit,” “-er(or),” etc., as used for the ciphertext obtainer 121, the converter 122, the operation unit 123, and the ciphertext provider 124 may refer to a part for processing at least one function or operation and may be implemented as hardware, software, or a combination of hardware and software. For example, the ciphertext obtainer 121, the converter 122, the operation unit 123, and the ciphertext provider 124 may be implemented with one or more processors.

In an example, the second device 120 may be implemented by more components than the illustrated components and the second device 120 may be implemented by fewer components. For example, the second device 120 may further include a memory. The processor may process data stored in a memory. The processor may execute a computer-readable code (for example, software) stored in the memory and instructions triggered by the processor.

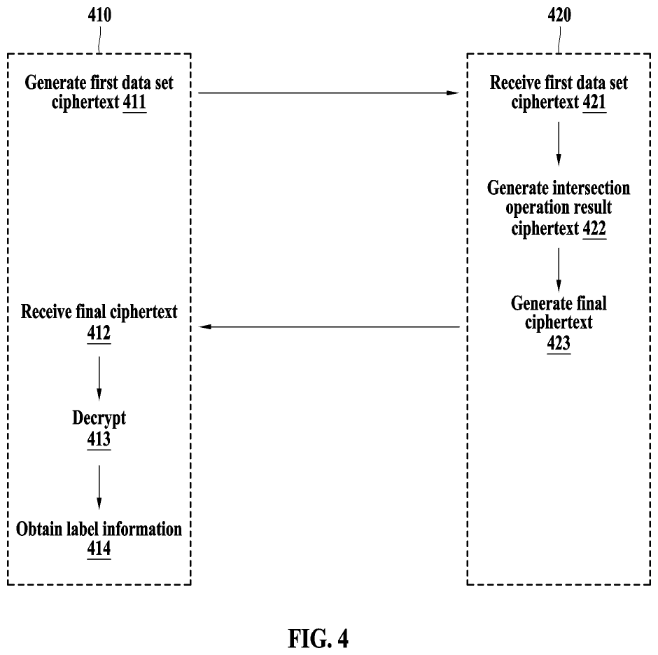

FIG. 4 illustrates example operations of a first electronic device and a second electronic device according to one or more embodiments. The description provided with reference to FIGS. 1A to 3 may also apply to FIG. 4.

Referring to FIG. 4, in a non-limiting example, in operation 411, a first device (e.g., the first device 410) of an electronic apparatus for encryption (e.g., the electronic apparatus 100) may generate ciphertext corresponding elements of a first data set. The ciphertext may be RLWE-based ciphertext. The first device may transmit the ciphertext to a second device (i.e., the second device 420) of the electronic apparatus (i.e., the electronic apparatus 100).

In an example, in operation 421, the second device may receive the ciphertext corresponding to the elements of the first data set from the first device.

In an example, in operation 422, the second device may generate intersection operation result ciphertext by performing an intersection operation between the ciphertext and elements of a second data set based on a matching function defined for the elements of the second data set. Through this, the second device may identify a common element through the intersection operation.

In an example, in operation 433, the second device may generate final ciphertext. The second device may calculate a matching function using encrypted data received from a client and the second data set and may generate the final ciphertext by integrating label information on each element corresponding to the intersection.

In an example, in operation 412, the first device may receive at least one of the final ciphertext and the intersection operation result ciphertext from the second device. In operation 413, the first device may decrypt the ciphertext (e.g., the final ciphertext and/or the intersection operation result ciphertext) received from the second device, and in operation 414, the first device may simultaneously obtain an intersection element and corresponding label information.

FIG. 5 illustrates an example method of generating final ciphertext according to one or more embodiments. The description provided with reference to FIGS. 1A to 4 may also apply to FIG. 5.

Referring to FIG. 5, in a non-limiting example, a first device (e.g., the first device 110 of FIG. 1A or the first device 410 of FIG. 4) may retain a first data set Y={y₁, y₂, . . . , yₙ} and a second device (e.g., the second device 120 of FIG. 1A or a second device 420 of FIG. 4) may retain a second data set X={x₁, x₂, . . . , xₘ} (where the n and m are natural numbers and m is greater than n). Furthermore, the second device may retain label information L={lₓ_{₁}, lₓ_{₁}, . . . , lₓ_{ₘ}} corresponding to the second data set.

The first device may generate ciphertext Enc(y)={Enc(y₁), Enc(y₂), . . . , Enc(yₙ)} by encrypting each element of the first data set Y using an encryption function Enc. The second device may obtain the ciphertext Enc(y) from the first device.

In an example, in operation 510, the second device may generate intersection operation result ciphertext by performing an intersection operation between the ciphertext and the elements of the second data set based on a matching function defined for the elements of the second data set according to Equation 7. For example, the second device may generate the intersection operation result ciphertext as Equation 10 below.

$$F ( {x}_{1} ) = ( {x}_{1} - Enc ( {y}_{1} ) ) ( {x}_{1} - Enc ( {y}_{2} ) ) ⋯ ( {x}_{1} - Enc ( {y}_{n} ) ) \qquad Equation 10$$

$$F ( {x}_{2} ) = ( {x}_{2} - Enc ( {y}_{1} ) ) ( {x}_{2} - Enc ( {y}_{2} ) ) ⋯ ( {x}_{2} - Enc ( {y}_{n} ) )$$

$$⋮$$

$$F ( {x}_{m} ) = ( {x}_{m} - Enc ( {y}_{1} ) ) ( {x}_{m} - Enc ( {y}_{2} ) ) ⋯ ( {x}_{m} - Enc ( {y}_{n} ) )$$

Referring to Equation 10, in an example, a matching function may perform an operation while an element of the second data set is fixed, unlike typical methods of performing a matching function operation (e.g., performing an operation according to Equation 1) while fixing an element of the first data set. Furthermore, since the number of elements of the first data set is less than the number of elements of the second data set, the number of multiplication operations of the intersection operation result ciphertext may be reduced compared to the conventional case.

In an example, in operation 520, the second device may generate random number ciphertext based on a random number and the intersection operation result ciphertext. For example, the second device may generate random number ciphertext ctᵣ=r·ct by multiplying a random number r by the intersection operation result ciphertext ct.

In an example, in operation 530, the second device may obtain label information lₓ.

In an example, in operation 540, the second device may obtain label ciphertext Enc(lₓ) by encrypting the label information.

In an example, in operation 550, the second device may generate final ciphertext based on the intersection operation result ciphertext and the label ciphertext. For example, the second device may generate final ciphertext ctₒᵤₜ=ctᵣ+Enc(lₓ) by adding the random number ciphertext ct, to the label ciphertext Enc(lₓ).

The second device may transmit the final ciphertext ctₒᵤₜ and the intersection operation result ciphertext ct to the first device. When a result of decrypting ct=F(Enc(yᵢ) is “0”, the first device may determine that a corresponding element yᵢ is included in the data set X of the second device. Furthermore, in this case, since the intersection operation result ciphertext ct is “0”, the random number ciphertext ctᵣ may have a value of “0”. Accordingly, the final ciphertext may have a value of Enc(lₓ) and the first device may obtain the label information lₓ corresponding to yᵢ by decrypting the final ciphertext by a secret key used by the second device for encryption.

Conversely, when there is no intersection between the first data set and the second data set, the final ciphertext may have a value of ctᵣ+Enc(lₓ) and the first device may not obtain the label information by decrypting the final ciphertext due to the random number ciphertext ctᵣ.

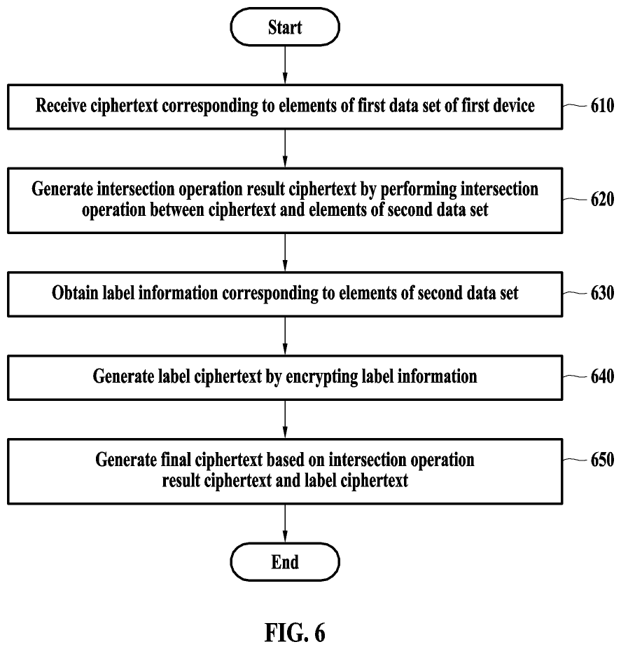

FIG. 6 illustrates an example method according to one or more embodiments.

For ease of description, the description is provided based on that operations 610 to 650 are performed by the second device (e.g., the second device 120 of FIG. 1A or the second device 420 of FIG. 4) described with reference to FIGS. 1A to 5. However, operations 610 to 650 may also be performed by any suitable electronic device and in any suitable system.

Furthermore, the operations of FIG. 6 may be performed in the shown order and manner. However, the order of some operations may change, or some operations may be omitted, without departing from the spirit and scope of the shown example. The operations shown in FIG. 6 may be performed in parallel or simultaneously.

Referring to FIG. 6, in a non-limiting example, in operation 610, the second device may receive, from the first device, ciphertext corresponding to elements of a first data set of the first device.

In an example, in operation 620, the second device may generate intersection operation result ciphertext by performing an intersection operation between the ciphertext and elements of a second data set based on a matching function defined for the elements of the second data set. For each element of the second data set, the second device may calculate differences between an element of the second data set and elements of the first data set and may generate the intersection operation result ciphertext by multiplying the differences.

In an example, in operation 630, the second device may obtain label information corresponding to the elements of the second data set.

In an example, in operation 640, the second device may generate label ciphertext by encrypting the label information.

In an example, in operation 650, the second device may generate final ciphertext based on the intersection operation result ciphertext and the label ciphertext. The second device may generate a random number and may generate random number ciphertext based on the random number and the intersection operation result ciphertext. The second device may generate random number ciphertext by multiplying the random number by the intersection operation result ciphertext. The second device may generate the final ciphertext based on the random number ciphertext and the label ciphertext. The second device may generate the final ciphertext by adding the random number ciphertext to the label ciphertext.

Among the elements of the second data set, a final ciphertext corresponding to an element included in an intersection with the first data set may be the same as the label ciphertext. That is, a matching function result and the label information may be integrated into one while the matching function result and the label information are encrypted and may be generated as the final ciphertext. Thus, data may be matched in an encrypted state without requiring an exposure of the encrypted data.

The second device may transmit the final ciphertext to the first device. The second device may also transmit the intersection operation result ciphertext to the first device.

In the final ciphertext generation, the accumulated number of homomorphic multiplication operations may be two. That is, the circuit depth of the label function may depend on the depth of the matching function. And as discussed above with respect to Equation 3, for example, the circuit depth may represent an accumulated number of homomorphic multiplication operations. When performing an intersection analysis on a set X that is relatively large using typical PSI protocols, the ciphertext size may be rather large and a large amount of computation may be required since the circuit depth is deep. On the other hand, when the circuit depth of the matching function is “1”, the circuit depth of the label function may be “2”, and thus, an electronic apparatus for encryption (e.g., the electronic apparatus 100) may be implemented as a relatively small homomorphic encryption parameter. Accordingly, the number of elements of the first data set may be less than the number of elements of the second data set.

The ciphertext may be RLWE-based ciphertext.

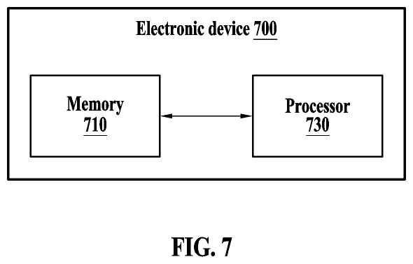

FIG. 7 illustrates an example electronic device according to one or more embodiments. The description provided with reference to FIGS. 1A to 6 may also apply to FIG. 7. For example, an electronic device 700 may include the second device 120 of FIG. 1A and the second device 420 of FIG. 4.

Referring to FIG. 7, in a non-limiting example, the electronic device 700 may include a memory 710 and a processor 730.

The memory 710 may include computer-readable instructions. The processor 730 may be configured to execute computer-readable instructions, such as those stored in the memory 710, and through execution of the computer-readable instructions, the processor 730 is configured to perform one or more, or any combination, of the operations and/or methods described herein. The memory 710 may be a volatile or nonvolatile memory. The processor 730 may be configured to execute programs or applications to configure the processor 730 to control the electronic apparatus 700 to perform one or more or all operations and/or methods involving encryption, performing a private set intersection (PSI) operation, and homomorphic encryption. In addition, the processor 730 (or processors) may execute instructions (e.g., code and/or programs), and/or may control other operations or functions of the second device 120 which may perform operations including operations of the ciphertext obtainer 121, operation unit 123, ciphertext provider 124, label information obtainer 122. In addition, the first device 110 may include also processors, which may perform operations including operations of the converter 111, encryptor 112, ciphertext obtainer 113, decryptor 114, and operations of the BFR apparatus (e.g., BFR apparatus 500), and may include any one or a combination of two or more of, for example, a central processing unit (CPU), a graphic processing unit (GPU), a neural processing unit (NPU), a processor core, a multi-core processor, a multiprocessor, an application-specific integrated circuit (ASIC), and a field-programmable gate array (FPGA), and tensor processing units (TPUs), but is not limited to the above-described examples.

The second device 120 of FIG. 1A and the second device 420 of FIG. 4 may be stored in the memory 710 and may be executed by the processor 730 or may be embedded by the processor 730. The processor 730 may perform operations of the second device described with reference to FIGS. 1A to 6 in substantially the same manner. Accordingly, a detailed description thereof is omitted.

The electronic apparatuses, electronic device, processors, memories, electronic device 100, first device 110, second device 120, converter 111, encryptor 112, ciphertext obtainer 113, decryptor 114, ciphertext obtainer 121, operation unit 123, ciphertext provider 124, label information obtainer 122, first device 410, second device 420, electronic device 700, processor 730, and memory 720 described herein and disclosed herein described with respect to FIGS. 1-7 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-7 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
generating intersection operation result ciphertext by performing an intersection operation between a first ciphertext, the first ciphertext corresponding to elements of a first data set of a first device, and elements of a second data set of a second device, based on a matching function defined for the elements of the second data set;
generating a label ciphertext by encrypting label information obtained from the elements of the second data set; and
generating a final ciphertext based on the intersection operation result ciphertext and the label ciphertext.

2. The method of claim 1, wherein the generating of the final ciphertext comprises:
generating random number ciphertext based on a generated random number and the intersection operation result ciphertext; and
generating the final ciphertext based on the random number ciphertext and the label ciphertext.

3. The method of claim 2, wherein the generating of the random number ciphertext comprises:
multiplying the random number by the intersection operation result ciphertext to generate the random number ciphertext.

4. The method of claim 2, wherein the generating of the final ciphertext comprises:
adding the random number ciphertext to the label ciphertext to generate the final ciphertext.

5. The method of claim 1, wherein, among the elements of the second data set, a final ciphertext corresponding to an element included in an intersection with the first data set is the same as the label ciphertext.

6. The method of claim 1, wherein the generating of the intersection operation result ciphertext comprises:
for each element of the second data set, calculating differences between an element of the second data set and the elements of the first data set; and
generating the intersection operation result ciphertext by multiplying the calculated differences.

7. The method of claim 1, further comprising:
transmitting the final ciphertext to the first device,
wherein the first device provided the first ciphertext.

8. The method of claim 1, wherein a first number of elements of the first data set is less than a second number of elements of the second data set.

9. The method of claim 1, wherein, in generating the final ciphertext, an accumulated number of homomorphic encryption operations is two.

10. The method of claim 1, wherein the ciphertext is a ring learning with error (RLWE)-based ciphertext.

11. A non-transitory computer-readable storage medium storing instructions that, when executed by a processor, cause the processor to perform the method of claim 1.

12. An electronic device, comprising:
processors configured to execute instructions; and
a memory storing the instructions, wherein execution of the instructions configures the processors to:
perform an intersection operation between a first ciphertext, the first ciphertext including first elements of a first data set, and second elements of a second data set to generate an intersection operation result ciphertext based on a matching function defined for the elements of the second data set,
generate a label ciphertext by encrypting label information from the second elements of the second data set, and
generate a final ciphertext based on the intersection operation result ciphertext and the label ciphertext.

13. The electronic device of claim 12, wherein the processors are further configured to:
generate a random number ciphertext based on a generated random number and the intersection operation result ciphertext, and
generate the final ciphertext based on the random number ciphertext and the label ciphertext.

14. The electronic device of claim 13, wherein the processors are further configured to:
multiply the random number by the intersection operation result ciphertext to generate the random number ciphertext.

15. The electronic device of claim 13, wherein the processors are further configured to:
add the random number ciphertext to the label ciphertext to generate the final ciphertext.

16. The electronic device of claim 12, wherein, among the elements of the second data set, a final ciphertext corresponding to an element included in an intersection with the first data set is the same as the label ciphertext.

17. The electronic device of claim 12, wherein the processors are further configured to:
for each element of the second data set, calculate differences between an element of the second data set and the elements of the first data set, and
generate the intersection operation result ciphertext by multiplying the calculated differences.

18. The electronic device of claim 12, wherein a first device provided the first ciphertext,
wherein a second device provided the second data set, and
wherein the processors are further configured to:
transmit the final ciphertext to the first device.

19. The electronic device of claim 12, wherein a first number of elements of the first data set is less than a second number of elements of the second data set.

20. The electronic device of claim 12, wherein, in generating the final ciphertext, an accumulated number of homomorphic encryption operations is two.
